(19) United States
(12) Patent Application Publication
(10) Pub. No.: US 2014/0291563 A1
(43) Pub. Date: Oct. 2, 2014

(54) Actuating Device having a Rotationally Secured Holding Nut

(71) Applicant: Robert Bosch GmbH, Stuttgart (DE)

(72) Inventors: Christian Doerner, Lohr am Main (DE); André Selke, Naumburg (DE); Liebhart Zaiser, Karlstadt (DE); Matthias Lang, Roden-Ansbach (DE); Juergen Gruen, Lohr am Main (DE)

(73) Assignee: Robert Bosch GmbH, Stuttgart (DE)

(21) Appl. No.: 14/220,989

(22) Filed: Mar. 20, 2014

(30) Foreign Application Priority Data
Mar. 27, 2013 (DE) 10 2013 205 395.9

(51) Int. Cl. F16K 31/06

(52) U.S. Cl. CPC F16K 31/0658
USPC 251/129.15

(57) ABSTRACT

An actuating device for a control body of a valve includes an armature guide configured to receive a magnetic armature and an armature plunger in such a manner that the magnetic armature and armature plunger can move in relation to a longitudinal direction. An outer thread is located on a longitudinal end of the armature guide that is remote from the armature plunger. The outer thread includes a first cross-sectional profile forming a thread tip that points towards an exterior. A holding nut having an inner thread is screwed onto the outer thread of the armature guide and lies at least indirectly on the synthetic material casing of the electrical coil. The inner thread includes a second cross-sectional profile that is complementary to the first cross-sectional profile, and a thread base configured in a clamping region in a gap free manner with respect to the first cross-sectional profile.

This application claims priority under 35 U.S.C. §119 to patent application no. DE 10 2013 205 395.9, filed on Mar. 17, 2013 in Germany, the disclosure of which is incorporated herein by reference in its entirety.

The disclosure relates to an actuating device.

### BACKGROUND

An actuating device for the control body of a hydraulic valve is disclosed in DE 199 52 800 A1. The actuating device comprises an armature guide, in which a magnetic armature and an armature plunger are received in such a manner that they can move in relation to a longitudinal direction. The armature plunger protrudes out of the armature guide at the end that is remote from the magnetic armature so that its front end face in that region can be brought into physical contact with a front end face of the control body in the form of a control slide so that the magnetic armature is coupled to the control body by way of the armature plunger in such a manner that said components can move simultaneously. An electrical coil is provided around the armature guide and said electrical coil is encased by a synthetic material casing. In order to produce the synthetic material casing, the coil is inserted into a mold, wherein subsequently viscous synthetic material is poured into the mold where said viscous synthetic material then hardens. The synthetic material encases the coil in such a manner that said coil is sealed in a fluid-tight manner. An outer thread is provided on the end of the armature guide that is remote from the armature plunger, and the inner thread of a holding nut is screwed onto said outer thread. The synthetic material casing of the armature guide is braced against the housing of the valve by way of the holding nut.

The disadvantage of the known actuating device is that the synthetic material casing is exposed to considerable temperature fluctuations as a result of the alternating strength of the electrical current that is flowing in the coil. In this case, the length of the synthetic material casing changes in part to such an extent that the pre-stressing arrangement between the holding nut and the synthetic material casing is rendered completely ineffective. The holding nut subsequently becomes detached from the armature guide. Furthermore, the mentioned pre-stressing arrangement can be rendered ineffective the ageing process.

### SUMMARY

The object of the disclosure is to prevent the holding nut from becoming detached. Furthermore, the actuating device is to be particularly cost-effective.

This object is achieved by virtue of the fact that the cross sectional profile of the outer thread comprises a first outer flank and a second outer flank that taper towards one another to form a thread tip that points toward the exterior, wherein the cross sectional profile of the inner thread comprises a first inner flank and a second inner flank that are embodied in such a manner that complements the first outer flank and the second outer flank, wherein the first inner flank and the second inner flank are connected to one another by way of a thread base, wherein the thread base is adapted in a clamping region in a gap free manner with respect to the thread tip, wherein the thread base is embodied outside the clamping region with a gap with respect to the first outer flank and the second outer flank. It is in particular possible to produce the thread base in the new state in such a manner that said thread base overlaps the armature guide in that region with the thread tip during the process of screwing on the holding nut. The thread base subsequently deforms in both a plastic as well as a resilient manner. The thread tip and the thread base come into physical contact with one another in the clamping region as a result of this process of deforming under pre-stressing and therefore produce a gap free arrangement. This pre-stressing arrangement is itself then not rendered ineffective, if the pre-stressing arrangement between the synthetic material casing and the holding nut is rendered ineffective as a result of the temperature change. The holding nut can therefore not become detached from the armature guide. It is to be noted that additional parts can be located between the holding nut and the synthetic material casing, by way of example an O-ring.

Advantageous developments and improvements of the disclosure are disclosed in the claims.

The thread base can extend parallel to the longitudinal direction at least in sections when regarded in the cross section. It is preferably possible that the thread base is embodied in the new state entirely parallel to the longitudinal direction so that said thread base defines a cylindrical surface. The clamping region is only formed during the process of screwing the holding nut onto the armature guide.

The outer thread of the armature guide can be embodied from metal, wherein at least the inner thread of the holding nut, preferably the entire holding nut, is embodied from synthetic material. As a consequence, it is ensured that only the thread base deforms on the holding nut. The thread tip on the armature guide deforms where necessary in a resilient manner. As a consequence, damage to the expensive armature guide is avoided. The cost-effective holding nut can be replaced in a problem-free manner if the safety device in accordance with the disclosure loses its effectiveness as a result of the holding nut being detached and screwed on multiple times.

The thread angle between the first outer flank and the second outer flank can amount to between 50° and 70°. It is preferred that the thread angle amounts to 60°. The corresponding thread comprises a high load capacity and a high level of reliability against becoming detached.

The first inner flank and the second inner flank and the first outer flank and the second outer flank can be embodied in a straight manner when regarded in the cross section. They can therefore be produced in a particularly simple manner. The above required complementary embodiment of outer and inner flanks means that the preferred straight flanks are embodied parallel with respect to one another.

The first outer flank and the second outer flank and the first inner flank the second inner flank can comprise clearance with respect to one another. As a consequence, it is ensured that the rotational resistance during the process of screwing the holding nut onto the armature guide occurs almost exclusively as a result of physical contact between the thread tip and the thread base. The rotational resistance only increases to a higher value when the holding nut lies at least directly under pre-stressing against the synthetic material casing.

### BRIEF DESCRIPTION OF THE DRAWINGS

The disclosure is further explained hereinunder with reference to the attached drawings. In the drawings:

FIG. 1 illustrates a simplified schematic cross sectional view of a valve having an actuating device in accordance with the disclosure;

FIG. 2 illustrates a perspective view of an armature guide in accordance with the disclosure having a holding nut; and

FIG. 3 illustrates a partial cross sectional view of the arrangement according to FIG. 2 in the region of the outer thread on the armature guide.

### DETAILED DESCRIPTION

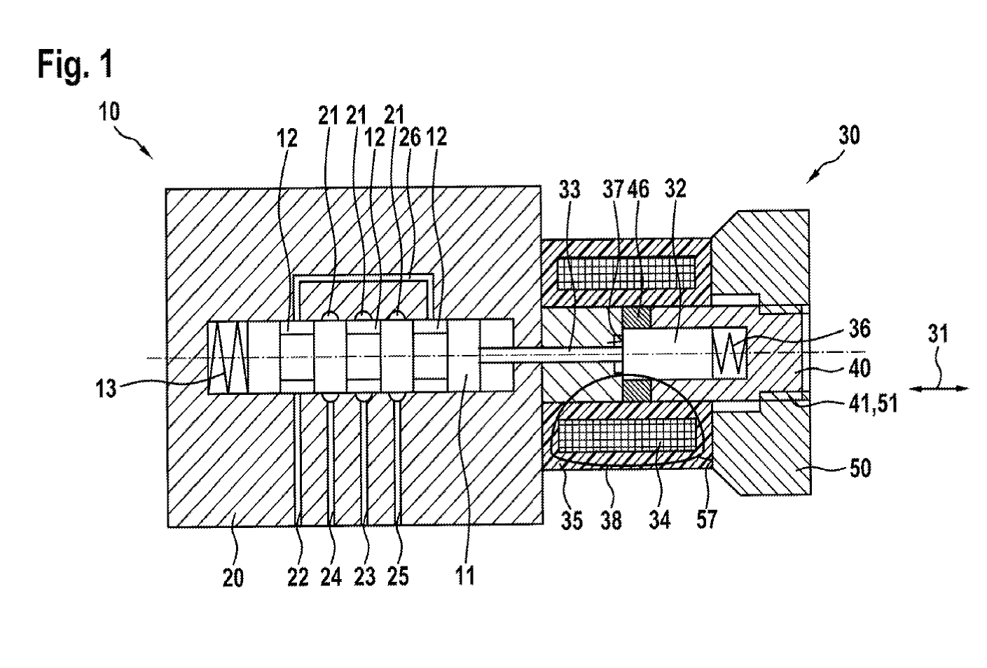

FIG. 1 illustrates a simplified schematic cross sectional view of a valve 10 having an actuating device 30 in accordance with the disclosure. The hydraulic valve 10 is illustrated in an exemplary manner as a slide valve, wherein the control body 11 is the control slide. However, the disclosure can also be used in the case of a seated valve. The valve 10 comprises a housing 20 that is embodied by way of example from cast iron. A control body 11 is received in the housing 20 in such a manner that it can move in a linear manner in relation to a longitudinal direction 31 and it is preferred that said control body is embodied from steel. It is preferred that the control body 11 is embodied with a high degree of accuracy in a circular cylindrical manner, wherein said control body by way of example is provided with three annular circumferential slide grooves 12. A circular cylindrical bore hole that is preferably adapted to comprise a very small amount of clearance with respect to the control body 11 is provided in the housing 20 and said bore hole is provided by way of example with three annular circumferential housing grooves 21. The slide grooves 12 and the housing grooves 21 delimit in each case allocated control apertures whose free cross sectional surface steadily changes in the case of movement of the control body 11 in the longitudinal direction 31. Furthermore, a reservoir duct 22, a pump duct 23, and a first working duct 24 and a second working duct 25 are provided in the housing 20, all of which are connected by way of the mentioned control apertures so that the fluid flow between the mentioned ducts 22-25 can be controlled. The exact interconnection of the mentioned ducts 22-25 can be changed within a wide range by means of a suitable arrangement of the slide grooves 12 and the housing grooves 21. Reference is also to be made to the connecting duct 26 that connects the reservoir duct 24 to an additional slide groove 12.

The actuating device 30 comprises an armature guide 40 that is embodied separately from the housing 20 in the present embodiment and is fixedly connected to said housing and by way of example screwed to said housing. It is however also possible to embody the armature guide 40 as one piece with the housing 20, wherein the valve 10 is preferably embodied in the form of a compact cartridge valve. The armature guide 40 is embodied for the most part from ferromagnetic material, by way of example from steel. It is divided in this case into two ferromagnetic regions by means of a non-magnetic flux interrupting section 46 that is embodied by way of example from copper. The corresponding armature guide 40 is produced by way of example in that two separate steel parts are welded together by means of additional copper material. Instead of the illustrated entire flux interrupter, it is also possible to embody the armature guide 40 in the flux interrupting section 46 in an extremely thin manner. The corresponding armature guide 40 is then more cost-effective, wherein the magnetic force is somewhat lower. Furthermore, additional methods for producing the flux interrupting section 46 are known, such as the process of welding in a non-magnetic zone, by way of example by means of resistance welding, laser welding or electron beam welding. Furthermore, the flux interrupting section 46 can be produced by means of localized heat treatment.

The exterior of the armature guide 40 is essentially embodied in a circular cylindrical manner, wherein it is surrounded by an electrical coil 34. Accordingly, the copper wire windings of the coil 34 extend in a helical manner around the armature guide 40. The mentioned copper wire windings of the coil 34 are surrounded by a synthetic material casing 35 that is produced by way of example in that the coil 34 is inserted into a mold that is subsequently filled with viscous synthetic material that hardens in the mold. The synthetic material can be a thermoset material or thermoplastic material. The coil 34 is encased in a fluid-tight manner by means of the synthetic material casing 35. The synthetic material casing 35 can in addition be surrounded by a (not illustrated) ferromagnetic housing and said ferromagnetic housing lies against the armature guide 40 in such a manner that the coil 34 is entirely surrounded on the outside at the flux interrupting section 46 by ferromagnetic material. This considerably increases the magnetic force of the actuating device 30.

The circular cylindrical magnetic armature 32 that is embodied from ferromagnetic material is received in such a manner that it can move in relation to the longitudinal direction 31 in a bore hole of the armature guide 40 that is adjusted to allow a small amount of clearance. The magnetic armature 32 is pressed by a second spring 36 in the direction of the control body 11, wherein simultaneously, the control body 11 is pushed by a clearly stronger first spring 13 against the separate armature plunger 33 and said armature plunger is arranged between the magnetic armature 32 and the control body 11. In this case it must be noted that the armature plunger 33 can also be embodied as one piece with the control body 11 and/or the magnetic armature 32. The armature plunger 33 is preferably embodied in an essentially circular cylindrical manner, wherein its diameter is smaller than the diameter of the control body 11 and the diameter of the magnetic armature 32.

The position of the magnetic armature 32 that is illustrated in FIG. 1 can only occur if electrical current flows through the coil 34. The magnetic field that is generated as a result of electrical current flowing through the coil produces a magnetic force on the magnetic armature 32 and said magnetic force moves the magnetic armature into a position in which the closed magnetic field lines 38 extend to the greatest extent possible entirely within the ferromagnetic material that surrounds the coil 34. For this purpose, it is necessary for the magnetic field lines to extend over the magnetic armature 32, since the flux interrupting section 46 is not magnetic. If electrical current does not flow through the coil 34, the magnetic armature 32 moves into the right hand end position that is illustrated in FIG. 1 as a result of the pre-stressing forces of the first spring 13 and the second spring 36, whereby a non-magnetic air gap is produced between the front end face 37 of the magnetic armature 32 and the armature guide 40.

An outer thread 41 is provided on the end of the armature guide 40 that is remote from the armature plunger 33, and a separate holding nut 50 is screwed onto said outer thread and said holding nut 50 is embodied entirely from synthetic material, by way of example polyamide. The holding nut 50 presses with its front end face 57 against the synthetic material casing 35 of the coil 34. The above mentioned ferromagnetic housing of the coil 34 can still be arranged between the synthetic material casing 35 and the holding nut 50. Furthermore, an 0-ring or a different sealing element can be provided there. The electrical current in the coil 34 heats the synthetic material casing 35 to a considerable extent, wherein said synthetic material casing cools if the mentioned current is disconnected. The changes in length of the synthetic material casing 35 that are caused as a consequence of this process cause a considerable fluctuation of the pre-stressing force of the holding nut 50. It is to be noted that the holding nut 50 is also deformed by means of the mentioned effect of heat. Furthermore, the holding nut 50 that is embodied from synthetic material is also deformed in the case of surrounding temperature changes by means of creeping so that the pre-stressing force of the screw connection reduces over time.

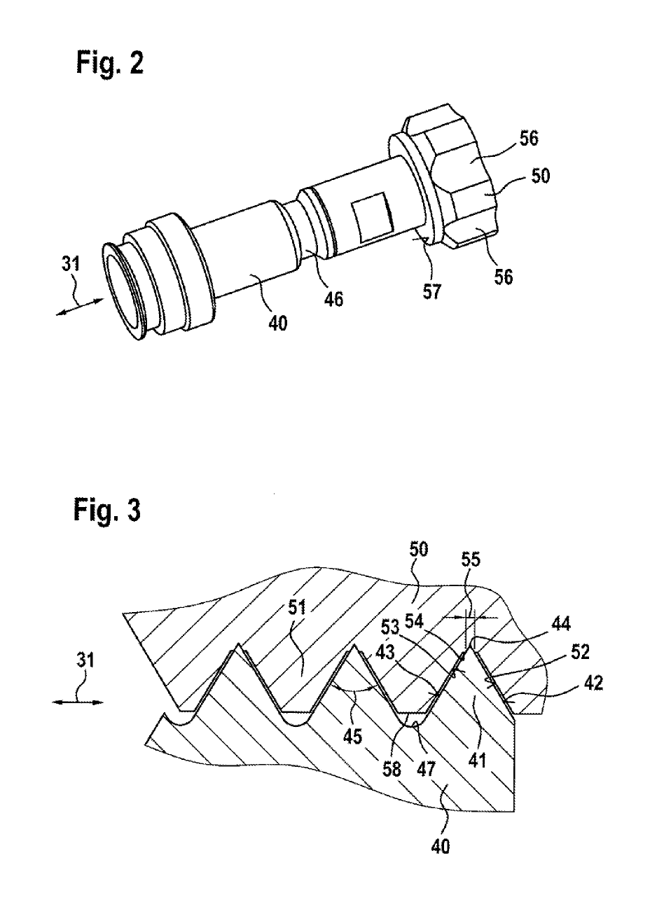

FIG. 2 illustrates a perspective view of an armature guide 40 in accordance with the disclosure having a holding nut 50. In the case of this armature guide 40, the flux interrupting section 46 is, as is mentioned above, embodied in such a manner that the armature guide is embodied from one uniform ferromagnetic material that has a very thin wall by way of example of 0.5 mm that is less than the wall thickness of the remaining armature guide 40. The side faces of the corresponding annular circumferential groove are embodied by way of example as cone-shaped, whereby a magnetic force is produced that is approximately proportional to the current strength in the coil. In addition, the grip grooves 56 that extend parallel to the longitudinal direction 31 and are on the holding nut 50 are evident here and said grip grooves are arranged in such a manner that they are equally distributed along the circumference of the holding nut 50. The holding nut 50 can be secured and detached in a simpler manner by hand and also without the use of tools as a result of the grip grooves 56. However, the holding nut 50 can also be four sided or six sided.

FIG. 3 illustrates in part a cross sectional view of the arrangement according to FIG. 2 in the region of the outer thread 41 on the armature guide 40, wherein the sectional plane extends through the center axis of the outer thread 41. The outer thread 41 of the armature guide 40 has a first outer flank 42 and a second outer flank 43 and said outer flanks are embodied in a straight manner when regarded in the cross section, wherein they are arranged in a mirror-symmetrical manner with respect to a plane that is arranged perpendicular to the longitudinal direction 31. The first outer flank 42 and the second outer flank 43 taper towards one another to form a thread tip 44, wherein said outer flanks include a thread angle 45 of by way of example 60°. The thread base 47 of the outer thread is embodied in a rounded circular arcuate manner when regarded in the cross section. As illustrated in FIG. 3, the thread profile of outer thread 41 and inner thread 51 is constant across its entire length.

The inner thread 51 of the holding nut 50 comprises a first inner flank 52 and a second inner flank 53 and said inner flanks are arranged in a straight manner and parallel to the allocated first outer flank 42 or second outer flank 43 respectively when regarded in the cross section. A small amount of clearance is provided between the inner flanks 52, 53 and the outer flanks 42, 43. FIG. 3 illustrates approximately the clearance ratios that occur if the holding nut 50 is screwed onto the armature guide 40, wherein said holding nut is not yet braced by the synthetic material casing. As soon as the holding nut 50 is braced by the synthetic material casing, the second outer flank 43 and the second inner flank 53 that are facing from the synthetic material casing lie against one another, wherein the clearance on the opposite lying side is correspondingly increased.

The first inner flank 52 and the second inner flank 53 are connected to one another by way of a thread base 54 that extends in a straight manner and parallel to the longitudinal direction when regarded in the cross section, wherein said thread base lies against the thread tip 44 of the outer thread in a clamping region 55 in a gap free manner. The diameter that is defined by the thread base outside the clamping region 55 is accordingly smaller than the diameter that is defined by the thread tip 44 of the outer thread 41. There is a gap outside the clamping region 55 between the thread base 54 of the inner thread 51 and the first outer flank 42 and the second outer flank 43.

The first inner flank 52 and the second inner flank 53 are connected to one another by way of a thread head 58 that is embodied in a straight manner and parallel to the longitudinal direction 31 when regarded in the cross section. The thread head 58 of the inner thread 51 does not come into physical contact with the thread base 47 of the outer thread 40.

### LIST OF REFERENCE NUMERALS

10 Valve
11 Control Body
12 Slide groove
13 First Spring
20 Housing
21 Housing Groove
22 Reservoir Duct
23 Pump Duct
24 First Working Duct
25 Second Working Duct
26 Connecting Duct
30 Actuating Device
31 Longitudinal Direction
32 Magnetic Armature
33 Armature Plunger
34 Coil
35 Synthetic Material Casing
36 Second Spring
37 Front End Face of the Magnetic Armature
38 Magnetic Field Line
40 Armature guide
41 Outer Thread
42 First Outer Flank
43 Second Outer Flank
44 Thread Tip
45 Thread Angle
46 Flux Interrupting Section
47 Thread Base of the Outer Thread
50 Holding Nut
51 Inner Thread
52 First Inner Flank
53 Second Inner Flank
54 Thread base of the Inner Thread
55 Clamping Region
56 Grip Groove
57 Front End Face
58 Thread Head of the Inner Thread

What is claimed is:

1. An actuating device for a control body of a valve, comprising:
an armature guide that is surrounded by an electrical coil encased in a synthetic material casing, and that is configured to receive:
a magnetic armature; and
an armature plunger configured to be coupled to the control body on an end remote from the magnetic armature;
wherein the magnetic armature and the armature plunger are movable in relation to a longitudinal direction;
wherein the armature guide includes an outer thread on a longitudinal end of the armature guide remote from the armature plunger, the outer thread having a first outer flank and a second outer flank that taper together to form a thread tip that points towards an exterior; and
a holding nut that includes an inner thread and that is screwed on the outer thread and positioned at least indirectly on the synthetic material casing, wherein:
the inner thread comprises a first inner flank and a second inner flank that respectively complement the first outer flank and the second outer flank, and that are connected via a thread base; and
the thread base is configured in a clamping region in a gap free manner with respect to the first outer flank and the second outer flank.

2. The actuating device according to claim 1, wherein the thread base extends, at least in sections, parallel to the longitudinal direction in a perspective of a cross section.

3. The actuating device according to claim 1, wherein:
the outer thread comprises a metal; and
at least the inner thread of the holding nut comprises synthetic metal.

4. The actuating device according to claim 1, wherein a thread angle between the first outer flank and the second outer flank is between 50 degrees and 70 degrees.

5. The actuating device according to claim 1, wherein each of the first inner flank, the second inner flank, the first outer flank, and the second outer flank is respectively defined by a straight shape in a perspective of a cross section.

6. The actuating device according to claim 1, wherein each of the first inner flank, the second inner flank, the first outer flank, and the second outer flank are separated by a respective clearance.
